(19) United States
(12) Patent Application Publication
(10) Pub. No.: US 2018/0207460 A1
(43) Pub. Date: Jul. 26, 2018

(54) "TRF" (True UHP nozzle , RUFF, fire) nozzle

(71) Applicant: Brian Lee Abbott, Brooklyn Park, MN (US)

(72) Inventor: Brian Lee Abbott, Brooklyn Park, MN (US)

(21) Appl. No.: 15/364,705

(22) Filed: Jan. 26, 2017

(51) Int. Cl. A62C 31/05; B05B 1/12; B05B 1/30

(52) U.S. Cl. CPC A62C 31/05; B05B 1/30; B05B 1/12

(57) ABSTRACT

A complete Ultra High pressure (UHP) nozzle is coupled to a fluid source. A fluid management system comprised of an engine driven, UHP pump, connected to an UHP hose line. The fluid discharged from the UHP nozzle will deliver the optimum fluid droplet size allowing for the optimum disruption of the fire (science) triangle. The optimum fluid droplet size (diameter) greater than, or equal to, ˜70-160 microns, addressing the fire suppression stages, resulting in the effective and efficient fire attack, suppression, and overhaul.

Throughout history the source of a fluid, water being the most commonly used within the firefighting industry, high pressures ˜1100 psi-˜1800 psi have been proven to produce a fog, or mist, which is very effective in fighting multiple types of fires. Including, but not limited to, fuels, wild land, vehicle, structural, and airports. The most important element of a UHP system, the fluid mist, is to provide an efficient delivery and to meet the heat absorption parameters, which is accomplished by optimizing the fluid droplet size. Droplet size is critical in effective and efficient fire protection and suppression.

While existing UHP firefighting systems are viable for attack and fire suppression, their abilities have been limited to initial attacks, vehicle and wild land fires. The ability to provide extra protection to the fire fighter, advanced suppression/interior attacks, is not obtainable. The extended reach required with the master stream of liquid for large, structural/perimeter fires, or advanced interior structural attack is not obtainable. Specifically, maintaining optimum droplet size while introducing an added protective barrier, with an extended reach of the master stream, maintaining optimum droplet size cannot be delivered.

In order for advanced fire suppression and attack, existing UHP systems are required to rely upon the current, low pressure firefighting techniques and components.

### SUMMARY

Implementations described herein addresses the foregoing issues by providing an UHP nozzle delivering the optimum liquid droplet size for all aspects of fire suppression stages, attacks, and types. Providing and maintaining the maximum master stream fluid reach. Providing a protective fluid “fog/screen” for the firefighter while providing and maintaining the maximum master stream fluid reach.

It is a further feature of the present invention to provide an easily maintained and cost effective nozzle system.

It is a further feature of the invention to provide a lightweight, durable, and easily operated nozzle system.

### DESCRIPTION OF DRAWINGS

FIG. 1A: Illustrates, front plan view, the cylindrical design of the nozzle, and the orifice for the master liquid stream.

FIG. 1B: Illustrates, cross section of the nozzle, showing coupling attachment for UHP hose, master liquid stream flow tube and discharge orifice, and adjustable chamber for firefighter protective “fog”/“screen”.

FIG. 2A: Illustrates, 3-D left angle view of plan view, illustrating the cylindrical design

FIG. 2B: Illustrates, 3-D right angle view of plan view, illustrating cylindrical design

FIG. 2C: Illustrates, plan view, illustrating cylindrical design.

### DETAILED DESCRIPTIONS OF DRAWINGS

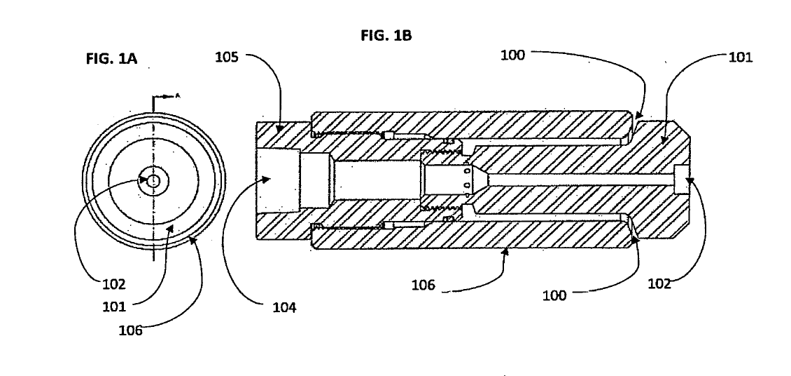

FIG. 1A illustrates the plan view of orifice for the main stream of fluid 102, the O.A. diameter of the complete body of the nozzle 106, and the O.A. diameter of the adjustable 101 component of the nozzle.

FIG. 1B illustrates the cross section of the full body nozzle 106, the coupler 105 that will accept and attach the UHP fire hose quick connect coupler. The chamber 104 allows the fluid source to enter into the body of the nozzle 106, allowing the pressurized fluid to create the fire fighter protective “fog/screen” 100 and the master stream 102. The adjustable chamber 101 rotates to increase and decrease the fire fighter protective “fog/screen” 100. The adjustable chamber 101 will rotate counterclockwise to open, and clockwise to close.

The full body nozzle 106 will be enclosed with a protective shroud, encasing all moving parts and shielded from debris, weather, environmental elements, and more. The protective shroud will allow ease of operation, one hand, to activate the fire fighter protective “fog/screen” 100 and ease of operation, one hand, to activate master fluid stream 102.

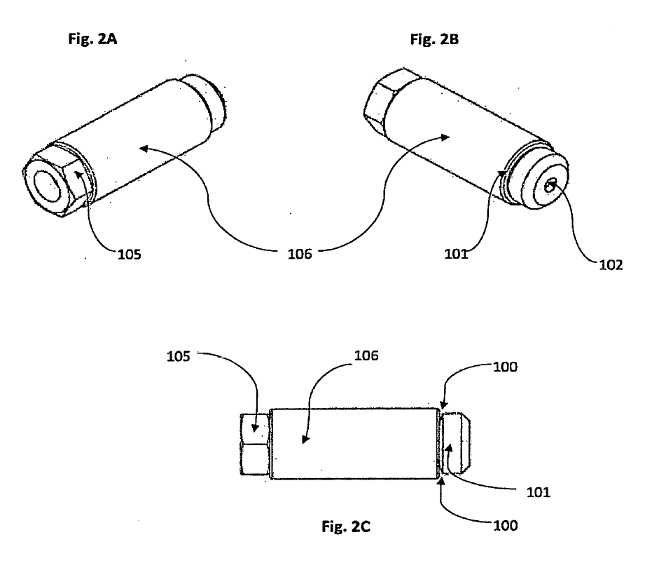

FIG. 2A illustrates the full body of the nozzle 106, in addition, the connecting coupler 105 the attachment of the UHP hose.

FIG. 2B illustrates the full body of the nozzle 106, in addition, the area of the emitted fluid to form the protective “fog/screen” 100, and the orifice for the master stream 102.

FIG. 2C illustrates the side plan view of the full body nozzle 106, the location of the connecting coupler 105 to the UHP hose, the area in which the protective “fog/screen” 100 emits from. The adjustable chamber 101 increases and decreases the protective “fog/screen” fluid flow by rotating the full body nozzle 100 clockwise to increase flow, and clockwise to decrease and turn off protective “fog/screen”.

1. An Ultra High Pressure (UHP) nozzle for fire suppression, prevention, exposure protection and comprising:
A configured quick connect/disconnect for the nozzle and protective shroud
A protective fluid “fog/screen” for the firefighter
A fluid (master) stream configured for a reach of ˜45′-0″-75′-0″
An optimum fluid droplet size for thermal layer knockdown and fire suppression, while maintain the above parameters.

2. An UHP nozzle according to claim 1, further comprising a configured selector to maintain continuous master stream while initiating the fluid “screen”

3. An UHP nozzle according to claim 2, wherein the selector is a rotating and locking sleeve, or shroud.

4. An UHP nozzle according to claim 1, wherein the pressurized fluid to be dispensed is at a pressure greater than, or equal to 1100 pounds per square inch, which at this time, UHP is defined by the NFPA to be greater than or equal to 1100 pounds per square inch.

5. An UHP nozzle according to claim 1, wherein the UHP nozzle is connected via UHP hose.

6. An UHP nozzle according to claim 5, wherein the UHP hose has an internal diameter, greater than or equal to ˜⅜ inch-1 inch.
